(19) United States
(12) Patent Application Publication
(10) Pub. No.: US 2016/0026711 A1
(43) Pub. Date: Jan. 28, 2016

(54) EVENT PROCESSING USING DISTRIBUTED TABLES FOR STORAGE SERVICES COMPATIBILITY

(71) Applicant: NetApp. Inc., Sunnyvale, CA (US)

(72) Inventors: Vladimir Radu Avram, Vancouver (CA); Oliver Erik Seiler, New Westminster (CA)

(21) Appl. No.: 14/338,286

(22) Filed: Jul. 22, 2014

(51) Int. Cl. G06F 17/30

(52) U.S. Cl. CPC G06F 17/30864; G06F 17/30339

(57) ABSTRACT

Technology is disclosed for enabling storage service compatibility. The technology. The technology receive a set of data storage events; process and resolve the received data storage events according to an application-specific logic; and return a result set of events after the processing and resolving, wherein the result set of events is a different set of data storage events that is based on the received set of data storage events.

### BACKGROUND

Various entities are increasingly relying on “cloud” storage services provided by various cloud storage vendors and so many applications have been designed to employ application program interfaces (“APIs”) provided by these vendors. Presently, a commonly used cloud storage service is AMAZON's Simple Storage Service (“S3”). A second commonly employed cloud storage service is MICROSOFT AZURE.

Although entities desire to use these applications that are designed to function with one or more cloud service APIs, they also sometimes want more control over how and where the data is stored. As an example, many entities prefer to use data storage systems that they have more control over, e.g., data storage servers commercialized by NetApp, Inc., of Sunnyvale, Calif. Such data storage systems have met with significant commercial success because of their reliability and sophisticated capabilities that remain unmatched, even among cloud service vendors. Entities typically deploy these data storage systems in their own data centers or at “co-hosting” centers managed by a third party.

Data storage systems provide their own protocols and APIs that are different from the APIs provided by cloud service vendors and so applications designed to be used with one often cannot be used with the other. Thus, some entities that are interested in using applications designed for use on cloud storage services but with data storage systems they can exercise more control over.

### BRIEF DESCRIPTION OF THE DRAWINGS

FIG. 1 is a block diagram illustrating an environment in which the disclosed technology may operate in some embodiments.

FIG. 2 is a table diagram illustrating tables employed by the disclosed technology in various embodiments.

FIG. 3 is a flow diagram illustrating a routine invoked by the disclosed technology in various embodiments.

FIG. 4 is a flow diagram illustrating a routine invoked by the disclosed technology in various embodiments.

### DETAILED DESCRIPTION

Technology is disclosed for event processing using distributed tables for storage services compatibility (“disclosed technology”). In various embodiments, the disclosed technology supports capabilities for enabling a data storage system to provide aspects of a cloud data storage service API. The technology may employ an eventually consistent database for storing metadata relating to stored objects. The metadata can indicate various attributes relating to data that is stored separately. These attributes can include a mapping between how data stored at a data storage system may be represented at a cloud data storage service, e.g., an object storage namespace. For example, data may be stored in a file in the data storage service, but retrieved using an object identifier (e.g., similar to a uniform resource locator) provided by a cloud storage service.

A commercialized example of an eventually consistent database is “Cassandra,” but the technology can function with other databases. Such databases are capable of handling large amounts of data without a single point of failure, and are generally known in the art. These databases have partitions that can be clustered. Each partition can be stored in a separate computing device (“node”) and each row has an associated partition key that is the primary key for the table storing the row. Rows are clustered by the remaining columns of the key. Data that is stored at nodes is “eventually consistent,” because in that other locations may be informed of the additional data (or changed data) over time.

Changes to an object can be stored as separate data in Cassandra, e.g., as “events.” Each event can indicate a particular change to an object, e.g., creation, multiple updates, and delete. In some embodiments, a “generation” column of a table tracks the various events and is incremented so that the latest generation indicates the latest state. Eventually consistent databases like Cassandra can be very fast for write operations, but slower for some other operations. Thus, in some embodiments, every change or deletion can write an event. However, when multiple nodes are involved in an eventually consistent database, the disclosed technology performs additional processing to ensure that semantics, e.g., application semantics are enforced. As an example, a deletion of an object cannot precede creation of the object. The additional processing is done because a particular node may not have all events needed to reflect a current view for an object because additional events were stored at a different node.

Regardless of the sequence of events, the events can be broken down using a finite number of “base sequences” of events that map to a single event that in turn represents the chosen resolution of the sequence. The strategy to resolve a sequence of events to a “correct” state at the latest point in time becomes a substitution of base sequence resolutions into an original arbitrary sequence until a correct current state is reflected. To reflect the correct state, the following processing can occur: (1) events can be processed in time order; and (2) events occurring earlier in time are assumed not to apply to events occurring later.

The technology can include a resolution processor for each different application that is supported. As an example, the technology can include a first resolution processor for AMAZON S3 and a second resolution processor for a Cloud Data Management Interface (CDMI). These different resolution processors can process events according to their own respective storage application semantics and resolve conflicts according to their own protocols for doing so. As an example, a CDMI event processor may combine all events from oldest to newest in a timewise manner, but an S3 event processor may choose to ignore some events (e.g., a sequence of update events if there is a delete event later in time).

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

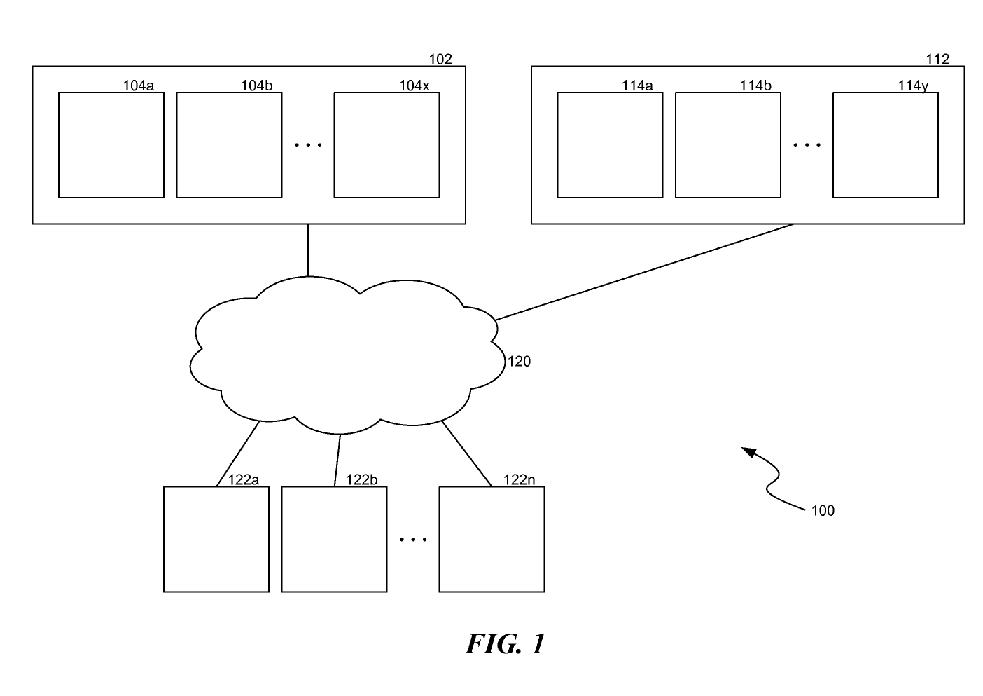

FIG. 1 is a block diagram illustrating an environment 100 in which the disclosed technology may operate in some embodiments. The environment 100 can include server computing devices 102 and server computing devices 112. The server computing devices 102 can be in a first data center and the server computing devices 112 can be in a second, different data center. In various embodiments, the different data centers can include a data center of a cloud data services provider and a data center associated with an entity, e.g., a private data center or a co-hosted data center. As an example, the server computing devices 102 can include “nodes” 104a, 104b, up to 104x. The environment 100 can also include additional server computing devices that are not illustrated. The various data centers can be interconnected via a network 120 to each other and to client computing devices 122a, 122b, 122n, and so forth. The network 120 can be an intranet, the Internet, or a combination of the two.

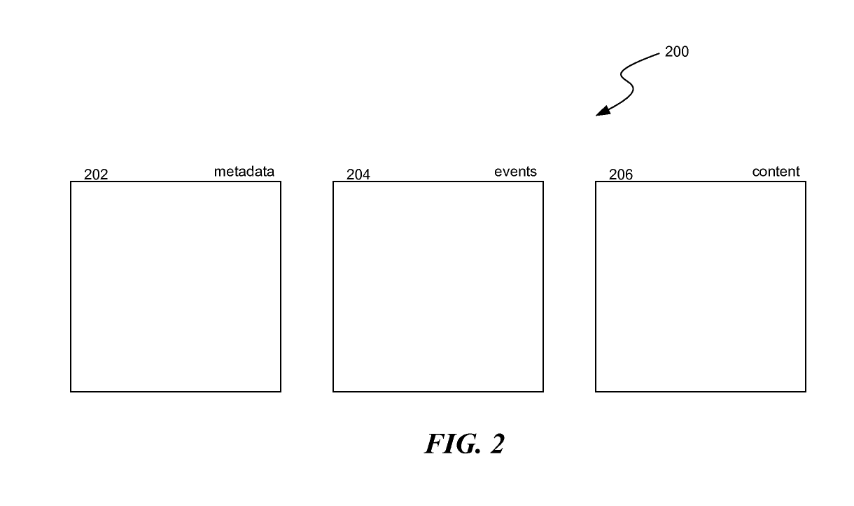

FIG. 2 is a table diagram illustrating tables 200 employed by the disclosed technology in various embodiments. In various embodiments, the tables 200 can include a metadata table 202, an events table 204, and a content table 206. The tables can be stored in different server “nodes” or the same server node. In various embodiments, metadata, events, and content can be distributed across multiple server nodes, e.g., using Cassandra and/or traditional data storage systems. The metadata table 202 can store metadata, e.g., to enable a mapping between object identifiers and files stored in a filesystem, e.g., as content 206. The events table 204 stores events corresponding to objects and/or metadata. As an example, the events can include create, update, and delete events.

While FIG. 2 illustrates a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

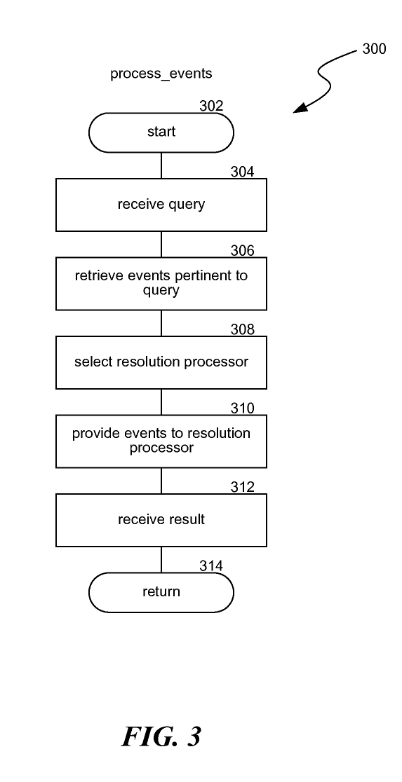

FIG. 3 is a flow diagram illustrating a routine 300 invoked by the disclosed technology in various embodiments. The disclosed technology can invoke the routine 300 to process events, e.g., upon receiving a query. The routine 300 begins at block 302. At block 304, the routine 300 receives a query. At block 306, the routine 300 retrieves events pertinent to the received query. As an example, the routine 300 may retrieve events that identify a key, object identifier, or other information that can be used to identify pertinent events. At block 308, the routine 300 selects a resolution processor. As an example, if the events are associated with invocations of an AMAZON S3 API, then an s3 resolution processor can be selected; or if the events are associated with invocations of a CDMI API, then a CDMI resolution processor can be selected. At block 310, the routine 300 provides the retrieved events to the selected resolution processor. At block 312, the routine 300 receives one or more results (e.g., a single event or query results) from the selected resolution processor. At block 314, the routine 300 returns the received results.

Those skilled in the art will appreciate that the logic illustrated in FIG. 3 and described above, and in each of the flow diagrams discussed below, may be altered in a variety of ways. For example, the order of the logic may be rearranged, substeps may be performed in parallel, illustrated logic may be omitted, other logic may be included, etc.

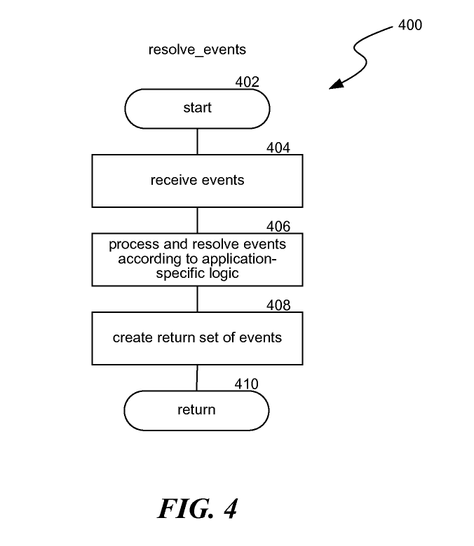

FIG. 4 is a flow diagram illustrating a routine 400 invoked by the disclosed technology in various embodiments. The disclosed technology can invoke the routine 400 to resolve events. The routine 400 begins at block 402. At block 404, the routine receives events. At block 406, the routine 400 processes and resolves events according to application-specific logic. At block 408, the routine 400 creates a return set of zero or more events (or, alternatively, query results). The return set of events is a “roll-up” or combination of the received events, with resolutions for conflicts, elimination of unneeded events, etc. At block 410, the routine 400 returns.

Thus, the technology is capable of handling queries in an eventually consistent database, e.g., Cassandra, without locking rows. As is known in the art, locking rows would cause significant deterioration in performance.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing device, comprising:
receiving a set of data storage events, the events associated with an object storage application program interface;
selecting an application-specific resolver to resolve the events;
providing the data storage events to the application-specific resolver;
receiving a result set; and
returning the result set.

2. The method of claim 1, wherein the underlying database is an eventually consistent database.

3. The method of claim 1, wherein the application-specific resolver is configured to resolve events based on semantics associated with the object storage application program interface.

4. The method of claim 1, wherein the application-specific resolver is configured to resolve events based on semantics associated with a data storage application program interface other than the object storage application program interface.

5. The method of claim 4, wherein the application-specific resolver is configured to resolve events based on semantics associated with a cloud data management interface, and the object storage application program interface is a simple storage service interface.

6. The method of claim 4, wherein the querying includes determining whether a row is active.

7. The method of claim 1, wherein the result set comprises zero or more events.

8. A non-transitory computer-readable storage medium storing computer-executable instructions, comprising:
instructions for receiving a set of data storage events;
instructions for processing and resolving the received data storage events according to an application-specific logic; and
returning a result set of events after the processing and resolving, wherein the result set of events is a different set of data storage events that is based on the received set of data storage events.

9. The computer-readable storage memory of claim 8, wherein the return set of data storage events includes zero or more data storage events.

10. The computer-readable storage memory of claim 9, wherein zero or more storage events are formed based on the application-specific logic.

11. The computer-readable storage memory of claim 10, wherein the application-specific logic is configured for a particular data storage application program interface.

12. The computer-readable storage memory of claim 11, wherein the data storage application program interface is a cloud data management interface.

12. The computer-readable storage memory of claim 11, wherein the data storage application program interface is a simple storage service interface.

14. A system, comprising:
a processor and memory;
a component configured to store data storage events across one or more server nodes;
a component configured retrieve the stored data storage events;
a component configured to receive a query and select, based on the query, a set of the stored data storage events;
a component configured to process and resolve the selected data storage events; and
a component configured to generate a result set of data storage events.

15. The system of claim 14, wherein the result set of data storage events is based on the set of the stored data storage events after the set of the stored data storage events is processed and resolved.

16. The system of claim 14, wherein the selected data storage events are processed according to semantics of a data storage application program interface.

17. The system of claim 16, wherein the application program interface is a cloud data management interface.

18. The system of claim 16, wherein the application program interface is a simple storage service interface.

19. The system of claim 14, wherein the storage events are stored in an eventually consistent database.

20. The system of claim 19, wherein the eventually consistent database is Cassandra.
